(19) United States
(12) Patent Application Publication
(10) Pub. No.: US 2014/0048644 A1
(43) Pub. Date: Feb. 20, 2014

(54) Wire-Advancement System Having Transporting Means Designed as a Transporting Belt or Transporting Chain and Having Cuboidal Pressure-Exerting Bodies

(71) Applicant: Karl Martin Weber, Wetzlar (DE)

(72) Inventor: Karl Martin Weber, Wetzlar (DE)

(73) Assignee: WSM Weber Schweissmaschinen, Grossen-Buseck (DE)

(21) Appl. No.: 13/983,958

(22) PCT Filed: Jan. 30, 2012
(86) PCT No.: PCT/DE2012/000077

§ 371 Date: Sep. 18, 2013

(30) Foreign Application Priority Data
Feb. 10, 2011 (DE) 102011010949.8

(51) Int. Cl. B21F 23/00; B65H 51/14; B23K 9/133

(52) U.S. Cl. CPC B21F 23/00; B23K 9/133; B65H 51/14
USPC 242/564.3

(57) ABSTRACT

A wire feeding system having a pressure element and a transport element, between which the wire is transported, and having at least one drive unit, wherein the transport element is designed as a transport belt or a transport chain, characterized in that the transport element and the pressure element each consist of cuboid-shaped pressure elements (4, 5) which are positioned opposite each other, and which have even pressing surfaces, wherein the transport belt or transport chains (6) run around the same.

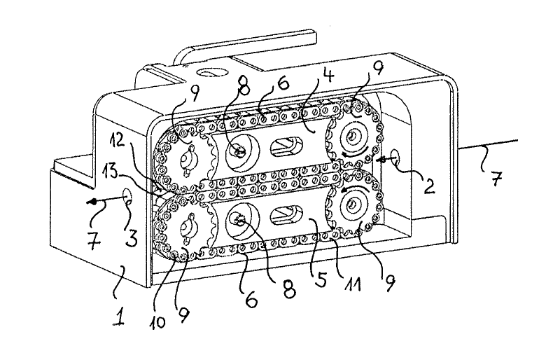

The invention relates to a wire feeding system having the features of the preamble of claim 1.

A wire feeding device is known from DD 250 517 A1, for the transport of wires for thermal spraying or welding systems.

The known wire feeding device evenly transports different wires for different applications, with different feeding speeds. The transport mechanism consists of three primary elements, particularly one transport element, one pressure element, and one adjusting element which generates different feeding speeds. Either transport rolls with a truncated cone shape, which are combined with truncated cone-shape pressure rollers as the pressure element, or profiled transport belts or chains which are combined with cylindrical pressure rollers, wherein wire guide grooves are machined into the peripheral cylindrical surface thereof, are used as transport elements. The wire is transported between the transport element and the pressure element.

A further known device consists of cylindrical wire feeding rolls with a circular, peripheral wire guide groove machined into the cylindrical surface, and cylindrical pressure rollers. The cylindrical pressure rollers are mounted in a guide part by means of which they are pressed against the wire feeding rolls. Adjustable pressure springs in the guide part enable the use of different wire diameters, and ensure adequate pressing force of the wire onto the guide grooves in the wire feeding rolls. The contact surfaces of the pressure rolls and pressure feeding rolls with the wire have a point shape.

The use of profiled transport belts or chains combined with cylindrical pressure rollers enables a stepless change in the feeding speed. For this purpose, the transport element is mounted on two pairs of tapered rollers, and is driven by the same. The tapered roller pairs can each be pushed toward each other axially by means of an adjusting device. As a result, the profiled transport belt or chains are moved to a larger or smaller radius of the tapered roller pairs. As such, the speed of the transport element, and at the same time the speed of the wire pressed by the cylindrical pressure rollers, changes. The pressing direction of the pressure roller is oriented parallel to the direction in which the transport belt or chain runs. In the case of this arrangement as well, point-shaped pressure surfaces are formed.

It is necessary to generate relatively high pressing forces for a slip-free feeding of wire, and this leads to a deformation of the wire cross-section when there are point-shaped pressing surfaces. The wire cross-section is matched to the shape of the guide groove, and this leads to a flattening on the cylindrical pressure roller. This effect particularly occurs with soft wires, such as aluminum, bronze, or flux-cord wires, and presents a hindrance for the insertion and guidance of the wire through spraying or welding nozzles. When multiple transport devices are arranged behind each other, the deformation of the cross-section leads to altered pressing conditions, and worsens the even advancement.

When the wire is accelerated rapidly, slipping between the wire and the transport device frequently occurs, such that less wire is conveyed than is specified. This is disadvantageous for the arc in precise welding, particularly with pulsed systems, because an imprecise conveyance of the wire leads to arc malfunctions and therefore welding errors.

When the surfaces of the pressure and transport cylinders are not oriented exactly parallel to each other, particularly flat wires are deformed more on one side than on the other side due to an uneven pressing force. As such, the wire comes out of the feeder with a curve, thereby hindering the further guidance thereof into the welding device.

The uneven wire conveyance resulting from the slipping additionally generates wear on the wire, which abrades the pressure and transport rollers.

Rapidly reversing feeders with a wire reversing function for special welding methods produce high degrees of conveyance imprecision in the known devices, such that a reversing pulse mode is nearly impossible.

Therefore, the problem addressed by the invention is that of providing a wire feeding system which does not have the described disadvantages.

This problem is addressed according to the invention, in a wire feeding system in the class named above, by the characterizing features of claim 1. Advantageous implementations are found in the features of the dependent claims.

The cuboid-shaped pressure elements of the transport and pressure elements enable a large contact surface of the wires between the circulating transport belts or chains. The pressure load of the wires can be kept so small that even soft wires are not deformed. Because of the large contact surface, there is no slipping. As a result, no imprecision in the conveyance is created. The parallel pressing between the even surfaces of the pressure elements is particularly optimum for the conveyance of flat wires. Because there is no slipping, there is also no wear, and particularly neither on the wire nor on the transport chain. This means, in particular, that a copper coating—which is commonly present on the wire—is not damaged. The lack of slipping makes the wire feeding system according to the invention ideally suited for fast reversing movements of the wire, with precise conveyance with no length changes of the wire resulting from slipping.

One embodiment is illustrated schematically in the drawing, and is described below with reference to the drawing.

The wire feeding system illustrated in the drawing consists of a feeder housing 1, illustrated in the drawing with one side open, with a wire insertion opening 2 and a wire feed opening 3. Cuboid-shaped pressure elements 4, 5 are arranged opposite each other in the feeder housing 1, wherein transport chains 6 run around the same. The transport chains 6 transport the wire 7 between the pressure elements 4, 5.

The pressure elements 4, 5 are mounted in the feeder housing 1 in such a manner that they can be spring-loaded against each other to securely transport the wire 7. For this purpose, the lower pressure element 5 can be fixed and the upper pressure element 4 can be mounted in a guide under spring tension. The spring tension can be adjusted, and the tension of the transport chains 6 can be adjusted via adjusting screws 8 such that the transport chains 6 lie fixed on the deflecting rollers, which are not further illustrated, in the running direction before and after the pressure elements 4, 5.

Crown gears 9, which engage with pins 10 on the chain members 11, are coupled to the deflecting rollers or can be mounted in the same in a manner allowing rotation. The pins 10 are only illustrated in the region of the crown gears 9 to allow greater visibility. The chain members 11 have even transport surfaces 12, wherein guide grooves 13 are included in the same in the direction of travel for the wire 7 being transported. The guide grooves 13 provide an evenly-oriented transport of the wire 7 from the wire insertion opening 2 and out of the wire feed opening 3.

Electrical, synchronous motors or step motors, which are not further illustrated, are present in the feeder housing 1, for the purpose of driving the transport chains 6 via the crown gear 9. A very good synchronized running must be assured for the drive of the two transport chains 6 via separate motors, particularly for controlling the advancing and reversing movements in a reversing wire feed.

### LIST OF REFERENCE NUMBERS

1 Feeder housing
2 Wire insertion opening
3 Wire feed opening
4, 5 Cuboid pressure elements
6 Transport chains
7 Wire
8 Chain tension adjusting screw
9 Crown gears
10 Pins on the chain members
11 Chain member
12 Even transport surfaces
13 Guide grooves

1. A wire feeding system comprising:
a pressure element; and
a transport element, between which the wire is transported, and having at least one drive unit, wherein
the transport element is designed as a transport belt or a transport chain,
the transport element and the pressure element each consist of cuboid-shaped pressure elements which are positioned opposite each other, and which have even pressing surfaces, and
the transport belt or transport chains run around the same.

2. A wire feeding system according to claim 1, wherein the pressure elements can be spring-loaded against each other.

3. A wire feeding system according to claim 1, wherein deflecting rollers are arranged in front of and behind the pressure elements in the direction of travel, for the purpose of driving the transport belts or transport chains.

4. A wire feeding system according to claim 3, wherein the deflecting rollers are equipped with crown gears to engage in the chain members.

5. A wire feeding system according to claim 3, wherein synchronous motors are included for the purpose of driving the deflecting rollers.

6. A wire feeding system according to claim 3, wherein step motors are included for the purpose of driving the deflecting rollers.

7. A wire feeding system according to claim 1, wherein the transport chains have even transport surfaces of the chain members.

8. A wire feeding system according to claim 7, wherein guide grooves are included in the transport surfaces of the chain members, in the direction of travel, for the wire.

9. A wire feeding system comprising:
a first pressure element;
a second element;
a transport element; and
a drive unit, wherein
said first and second pressure elements have pressing surfaces positioned adjacent to one another,
said transport element is configured to carry said wire and surrounds said first and second pressure elements, and
said drive unit is configured to move said transport element.

10. The wire feeding system of claim 9, wherein said transport element is a transport chain.

11. The wire feeding system of claim 9, wherein said transport element is a transport belt.
